(19) United States
(12) Patent Application Publication
(10) Pub. No.: US 2026/0011109 A1
(43) Pub. Date: Jan. 8, 2026

(54) OBJECT DETECTION DEVICE, OBJECT DETECTION METHOD, AND COMPUTER READABLE MEDIUM

(71) Applicant: Mitsubishi Electric Corporation, Tokyo (JP)

(72) Inventor: Yoshihiro KOSEKI, Tokyo (JP)

(73) Assignee: Mitsubishi Electric Corporation, Tokyo (JP)

(21) Appl. No.: 19/327,305

(22) Filed: Sep. 12, 2025

Related U.S. Application Data
(63) Continuation of application No. PCT/JP2023/017220, filed on May 8, 2023.

(51) Int. Cl. G06V 10/25

(52) U.S. Cl. CPC G06V 10/25; G06V 2201/07

(57) ABSTRACT

A first detection unit (121) performs object detection on a target image (191) to calculate a detection result (192). A processing unit (130) fills in a target bounding box in the target image for each target bounding box to obtain a filled image group (193). A second detection unit (122) performs the object detection on each filled image to obtain a detection result group (194). A first removal unit (141) performs a first removal process on a detection result set to obtain a first result set (195). A second removal unit (142) performs a second removal process on the first result set to obtain a second result set (196) as an object detection result (197).

### CROSS REFERENCE TO RELATED APPLICATION

This application is a Continuation of PCT International Application No. PCT/JP2023/017220, filed on May 8, 2023, which is hereby expressly incorporated by reference into the present application.

### TECHNICAL FIELD

The present disclosure relates to a technology of detecting objects that are captured in images.

### BACKGROUND ART

A task of object detection involves indicating a position of each object in an input image with a bounding box, and indicating a type of each object with a label.

In recent years, deep learning methods using neural networks have achieved very high accuracy in tasks of object detection.

An image classifier (for example, a multi-class classifier) is constructed using deep learning.
Non-Patent Literature 1 describes adversarial example attacks that cause erroneous classification results by a multi-class classifier by adding perturbations to input data.

### CITATION LIST

### Non-Patent Literature

Non-Patent Literature 1: Christian Szegedy, Wojciech Zaremba, Ilya Sutskever, Joan Bruna, Dumitru Erhan, Ian J. Goodfellow and Rob Fergus: Intriguing properties of neural networks, in International Conference on Learning Representations (ICLR) (2014)

### SUMMARY OF INVENTION

### Technical Problem

An object of the present disclosure is to reduce the effectiveness of an adversarial example attack.

### Solution to Problem

An object detection device according to the present disclosure includes
a first detection unit to perform object detection on a target image to calculate a detection result indicating a bounding box group;
a processing unit to obtain a filled image group by, for each target bounding box selected from the bounding box group of the target image, filling in the target bounding box in the target image to generate a filled image;
a second detection unit to perform the object detection on the filled image for each filled image to obtain a detection result group for the filled image group;
a first removal unit to perform a first removal process on a detection result set to obtain the detection result set after a redundant bounding box has been removed as a first result set, the detection result set being composed of the detection result for the target image and the detection result group for the filled image group; and
a second removal unit to perform a second removal process on the first result set to obtain a second result set as a final result of the object detection on the target image, the second result set being the first result set after a redundant bounding box not removed by the first removal process has been removed.

### Advantageous Effects of Invention

According to the present disclosure, the effectiveness of an adversarial example attack can be reduced.

### BRIEF DESCRIPTION OF DRAWINGS

FIG. 1 is a configuration diagram of an object detection device 100 in Embodiment 1.

FIG. 2 is a functional configuration diagram of the object detection device 100 in Embodiment 1.

FIG. 3 is a flowchart of an object detection method in Embodiment 1.

FIG. 4 is a flowchart of step S150 in Embodiment 1.

FIG. 5 is a flowchart of step S160 in Embodiment 1.

FIG. 6 is a hardware configuration diagram of the object detection device 100 in Embodiment 1.

### DESCRIPTION OF EMBODIMENTS

In the embodiment and drawings, the same elements or corresponding elements are denoted by the same reference sign. Description of an element denoted by the same reference sign as that of an element that has been described will be suitably omitted or simplified. Arrows in diagrams mainly indicate flows of data or flows of processing.

### Embodiment 1

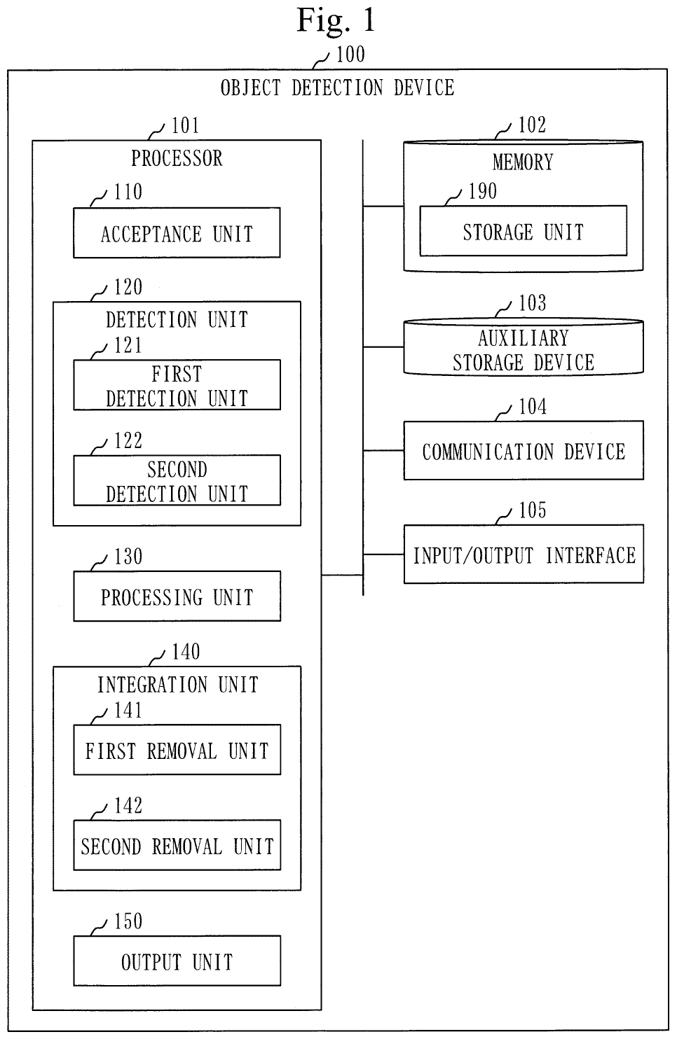

An object detection device 100 will be described based on FIGS. 1 to 6.

### ***Description of Configuration***

Based on FIG. 1, a configuration of the object detection device 100 will be described.

The object detection device 100 is a computer that includes hardware such as a processor 101, a memory 102, an auxiliary storage device 103, a communication device 104, and an input/output interface 105. These hardware components are connected with one another through signal lines.

The processor 101 is an IC that performs operational processing, and controls other hardware components. For example, the processor 101 is a CPU.

IC is an abbreviation for integrated circuit.

CPU is an abbreviation for central processing unit.

The memory 102 is a volatile or non-volatile storage device. The memory 102 is also called a main storage device or a main memory. For example, the memory 102 is a RAM. Data stored in the memory 102 is saved in the auxiliary storage device 103 as necessary.

RAM is an abbreviation for random access memory.

The auxiliary storage device 103 is a non-volatile storage device. For example, the auxiliary storage device 103 is a ROM, an HDD, a flash memory, or a combination of these. Data stored in the auxiliary storage device 103 is loaded into the memory 102 as necessary.

ROM is an abbreviation for read only memory.

HDD is an abbreviation for hard disk drive.

The communication device 104 is a receiver and a transmitter. For example, the communication device 104 is a communication chip or a NIC. Communication of the object detection device 100 is performed using the communication device 104.

NIC is an abbreviation for network interface card.

The input/output interface 105 is a port to which an input device and an output device are connected. For example, the input/output interface 105 is a USB terminal, the input device is a keyboard and a mouse, and the output device is a display. Input to and output from the object detection device 100 are performed using the input/output interface 105.

USB is an abbreviation for Universal Serial Bus.

The object detection device 100 includes elements such as an acceptance unit 110, a detection unit 120, a processing unit 130, an integration unit 140, and an output unit 150. These elements are realized by software.

The detection unit 120 includes a first detection unit 121 and a second detection unit 122.

The integration unit 140 includes a first removal unit 141 and a second removal unit 142.

The auxiliary storage device 103 stores an object detection program to cause a computer to function as the acceptance unit 110, the detection unit 120, the processing unit 130, the integration unit 140, and the output unit 150. The object detection program is loaded into the memory 102 and executed by the processor 101.

The auxiliary storage device 103 further stores an OS. At least part of the OS is loaded into the memory 102 and executed by the processor 101.

The processor 101 executes the object detection program while executing the OS.

OS is an abbreviation for operating system.

Input data and output data of the object detection program are stored in a storage unit 190.

The memory 102 functions as the storage unit 190. However, storage devices such as the auxiliary storage device 103, registers within the processor 101, and a cache memory within the processor 101 may function as the storage unit 190 in place of the memory 102 or together with the memory 102.

The object detection program can be recorded (stored) in a computer readable format in a non-volatile recording medium such as an optical disc or a flash memory.

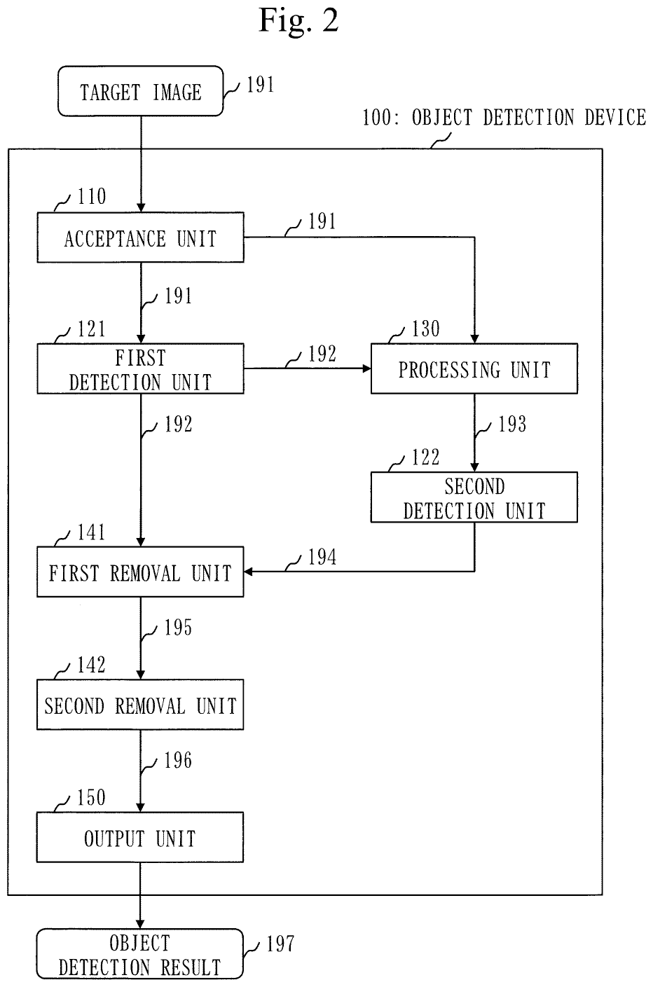

FIG. 2 illustrates a functional configuration of the object detection device 100.

Processing by and input data and output data of each element of the object detection device 100 will be described later.

### ***Description of Operation***

A procedure for the operation of the object detection device 100 is equivalent to an object detection method. The procedure for the operation of the object detection device 100 is also equivalent to a procedure for processing by the object detection program.

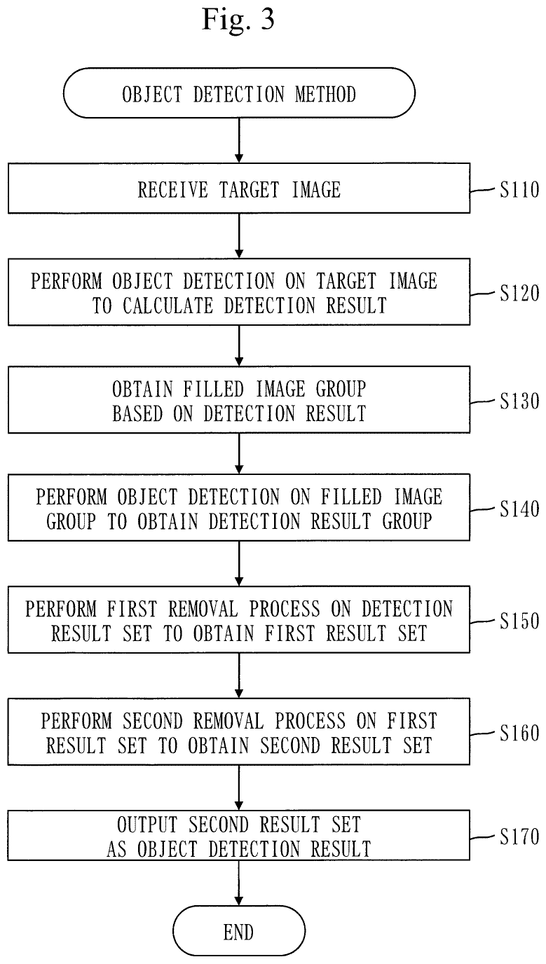

Based on FIG. 3, the object detection method will be described.

In step S110, the acceptance unit 110 receives a target image 191.

For example, a user inputs the target image 191 into the object detection device 100, and the acceptance unit 110 receives the target image 191 that has been input.

The target image 191 is data of an image on which object detection is performed.

In step S120, the first detection unit 121 performs object detection on the target image 191. As a result, a detection result 192 is calculated.

Object detection is performed using an object detector. For example, the object detector corresponds to a trained model, is realized by software, and is stored in advance in the storage unit 190.

The object detector is constructed using, for example, a neural network. A method such as YOLO, SSD, or Faster R-CNN is used for the object detector. YOLO is an abbreviation for You Only Look Once. SSD is an abbreviation for Single Shot MultiBox Detector. CNN is an abbreviation for convolutional neural network.

The first detection unit 121 performs object detection on the target image 191 by operating the object detector with the target image 191 as input.

The detection result 192 is a result of object detection (object detection result) on the target image 191.

The object detection result indicates one or more sets of a bounding box, a score value, and a label.

A bounding box is a rectangular area that encloses an object detected in an image, and is represented using coordinate values in the image.

A score value is a probability that represents a confidence level of the bounding box.

A label represents a type of the object within the bounding box.

One or more bounding boxes indicated in the object detection result are referred to as a bounding box group.

One or more score values indicated in the object detection result are referred to as a score value group.

One or more labels indicated in the object detection result are referred to as a label group.

The object detection result indicates the bounding box group, the score value group for the bounding box group, and the label group for the bounding box group.

In step S130, the processing unit 130 generates a filled image for each target bounding box selected from the bounding box group of the target image 191 by filling in the target bounding box in the target image 191. As a result, a filled image group 193 is obtained.

The bounding box group of the target image 191 is the bounding box group indicated in the detection result 192.

The filled image group 193 is composed of one or more filled images.

A filled image is the target image 191 in which the target bounding box has been filled in. The target bounding box is filled in a single color.

The target bounding box is a bounding box corresponding to each score value that falls within a predetermined range. The predetermined range is a certain range that is determined in advance for score values.

The target bounding box is selected as follows.

First, the processing unit 130 selects a score value that falls within the predetermined range from the score value group of the target image 191. The score value group of the target image 191 is the score value group indicated in the detection result 192.

Then, for each selected score value, the processing unit 130 selects a bounding box corresponding to the selected score value from the bounding box group of the target image 191. The selected bounding box is the target bounding box.

In step S140, for each filled image in the filled image group 193, the second detection unit 122 performs object detection on the filled image. As a result, a detection result group 194 is obtained.

The object detection performed in step S140 is the same as the object detection performed in step S120.

The detection result group 194 is a detection result group for the filled image group 193, and includes an object detection result for each filled image.

A set of the detection result 192 and the detection result group 194 is referred to as a detection result set.

In step S150, the first removal unit 141 performs a first removal process on the detection result set.

The first removal process is a process of removing a redundant bounding box based on the area of the intersection of bounding boxes of each pair of bounding boxes.

The first removal process corresponds to Non-Maximum Suppression (NMS). NMS is also performed in typical object detection.

Specifically, the first removal process is as follows.

A first reference bounding box is selected in descending order of the score values from the detection result set.

Each time the first reference bounding box is selected, a first evaluation value is calculated using each bounding box other than the first reference bounding box among the bounding boxes in the detection result set as a first comparison bounding box. If the first evaluation value satisfies a first removal condition, the first comparison bounding box is removed from the detection result set.

The first evaluation value is a value obtained by dividing the area of the intersection of the first reference bounding box and the first comparison bounding box by the area of the union of the first reference bounding box and the first comparison bounding box.

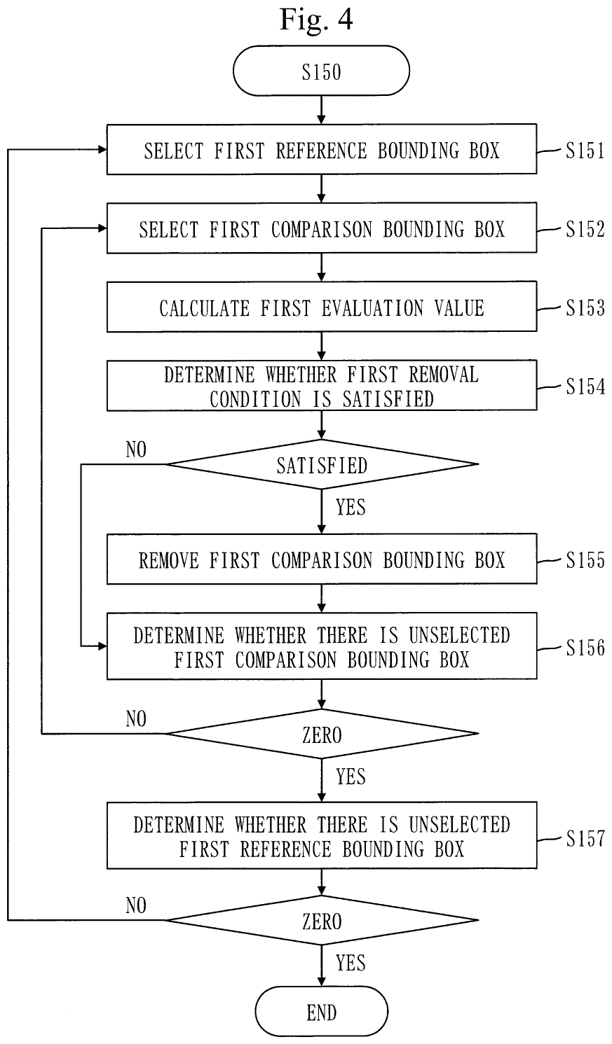

Based on FIG. 4, a procedure of step S150 will be described.

In step S151, the first removal unit 141 selects, from the detection result set, a bounding box with the highest score value among bounding boxes that have not been selected as the first reference bounding box.

The bounding box selected in step S151 is referred to as the first reference bounding box.

In step S152, the first removal unit 141 selects, from the detection result set, one of bounding boxes that have not been selected as the first comparison bounding box for the first reference bounding box. A bounding box different from the first reference bounding box is selected.

The bounding box selected in step S152 is referred to as the first comparison bounding box.

In step S153, the first removal unit 141 calculates the first evaluation value for a pair of the first reference bounding box and the first comparison bounding box.

The first evaluation value is closer to 1 as the overlap between the first reference bounding box and the first comparison bounding box is larger.

The first evaluation value is expressed as follows.

$$IOU = ( A ⋂ B ) / ( A ⋃ B )$$

IOU is the first evaluation value. IOU is an abbreviation for intersection over union.
“A” denotes the first reference bounding box.
“B” denotes the first comparison bounding box.
(A∩B) is the area of the intersection of the first reference bounding box and the first comparison bounding box.
(A∪B) is the area of the union of the first reference bounding box and the first comparison bounding box.

In step S154, the first removal unit 141 determines whether the first evaluation value satisfies the first removal condition.

Specifically, the first removal unit 141 compares the first evaluation value with a first threshold value, and determines whether the first evaluation value is equal to or greater than the first threshold value. If the first evaluation value is equal to or greater than the first threshold value, the first evaluation value satisfies the first removal condition. The first threshold value is a threshold value for the first removal process and is determined in advance.

If the first evaluation value satisfies the first removal condition, the process proceeds to step S155.

If the first evaluation value does not satisfy the first removal condition, the process proceeds to step S156.

In step S155, the first removal unit 141 removes the first comparison bounding box from the detection result set. This first comparison bounding box is a redundant bounding box.

In step S156, the first removal unit 141 determines whether there is an unselected first comparison bounding box in the detection result set.

An unselected first comparison bounding box is a bounding box that has not been selected as the first comparison bounding box for the first reference bounding box.

If there is an unselected first comparison bounding box in the detection result set, the process proceeds to step S152.

If there is no unselected first comparison bounding box in the detection result set, the process proceeds to step S157.

In step S157, the first removal unit 141 determines whether there is an unselected first reference bounding box in the detection result set.

An unselected first reference bounding box is a bounding box that has not been selected as the first reference bounding box.

If there is an unselected first reference bounding box in the detection result set, the process proceeds to step S151.

If there is no unselected first reference bounding box in the detection result set, step S150 ends.

Referring back to FIG. 3, the description will be continued.

As a result of step S150, a first result set 195 is obtained.

The first result set 195 is the detection result set after each redundant bounding box has been removed by the first removal process.

In step S160, the second removal unit 142 performs a second removal process on the first result set 195.

The second removal process is a process of removing a redundant bounding box based on the area of the intersection of bounding boxes of each pair of bounding boxes.

Specifically, the second removal process is as follows.

A second reference bounding box is selected in descending order of the areas from the first result set 195.

Each time the second reference bounding box is selected, a second evaluation value is calculated using each bounding box other than the second reference bounding box among the bounding boxes in the first result set 195 as a second comparison bounding box. If the second evaluation value satisfies a second removal condition, the second comparison bounding box is removed from the first result set 195.

The second evaluation value is a value obtained by dividing the area of the intersection of the second reference bounding box and the second comparison bounding box by the area of the second comparison bounding box.

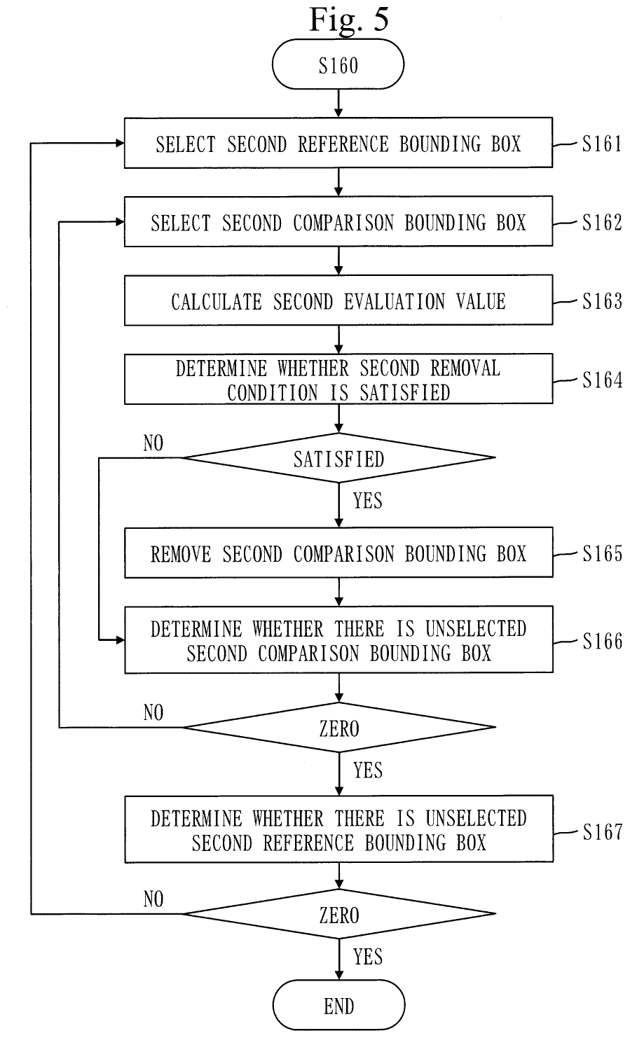

Based on FIG. 5, a procedure of step S160 will be described.

In step S161, the second removal unit 142 selects, from the first result set 195, a bounding box with the largest area among bounding boxes that have not been selected as the second reference bounding box.

The bounding box selected in step S161 is referred to as the second reference bounding box.

In step S162, the second removal unit 142 selects, from the first result set 195, one bounding box among bounding boxes that have not been selected as the second comparison bounding box for the second reference bounding box. A bounding box different from the second reference bounding box is selected.

The bounding box selected in step S162 is referred to as the second comparison bounding box.

In step S163, the second removal unit 142 calculates the second evaluation value for a pair of the second reference bounding box and the second comparison bounding box.

The second evaluation value is closer to 1 as a portion included in the second reference bounding box out of the entire second comparison bounding box is larger.

The second evaluation value is expressed as follows.

$$IOA = ( C ⋂ D ) / ( D )$$

IOA is the second evaluation value.
“C” denotes the second reference bounding box.
“D” denotes the second comparison bounding box.
(C∩D) is the area of the intersection of the second reference bounding box and the second comparison bounding box.
(D) is the area of the second comparison bounding box.

In step S164, the second removal unit 142 determines whether the second evaluation value satisfies the second removal condition.

Specifically, the second removal unit 142 compares the second evaluation value with a second threshold value, and determines whether the second evaluation value is equal to or greater than the second threshold value. If the second evaluation value is equal to or greater than the second threshold value, the second evaluation value satisfies the second removal condition. The second threshold value is a threshold value for the second removal process and is determined in advance.

If the second evaluation value satisfies the second removal condition, the process proceeds to step S165.

If the second evaluation value does not satisfy the second removal condition, the process proceeds to step S166.

In step S165, the second removal unit 142 removes the second comparison bounding box from the first result set 195. This second comparison bounding box is a redundant bounding box.

In step S166, the second removal unit 142 determines whether there is an unselected second comparison bounding box in the first result set 195.

An unselected second comparison bounding box is a bounding box that has not been selected as the second comparison bounding box for the second reference bounding box.

If there is an unselected second comparison bounding box in the first result set 195, the process proceeds to step S162.

If there is no unselected second comparison bounding box in the first result set 195, the process proceeds to step S167.

In step S167, the second removal unit 142 determines whether there is an unselected second reference bounding box in the first result set 195.

An unselected second reference bounding box is a bounding box that has not been selected as the second reference bounding box.

If there is an unselected second reference bounding box in the first result set 195, the process proceeds to step S161.

If there is no unselected second reference bounding box in the first result set 195, step S160 ends.

Referring back to FIG. 3, the description will be continued.

As a result of step S160, a second result set 196 is obtained.

The second result set 196 is the first result set 195 after each redundant bounding box not removed by the first removal process has been removed by the second removal process.

In step S170, the output unit 150 outputs the second result set 196 as an object detection result 197.

The object detection result 197 is a final result of object detection on the target image 191.

For example, the output unit 150 displays the object detection result 197 on the display.

### Features of Embodiment 1

In Embodiment 1, in order to deal with an adversarial example patch attack against object detection, the position of an adversarial example patch (target bounding box) is estimated based on the score value of a bounding box output from the object detector for an input image, and the estimated position is filled in. This reduces the effectiveness of the attack.

In Embodiment 1, the first removal process and the second removal process are performed on detection results for an image before filling and an image group after filling so as to remove redundant bounding boxes, and the remaining bounding boxes are output as correct bounding boxes in which the attack has been neutralized.

### Effects of Embodiment 1

According to Embodiment 1, even if an attack that evades object detection using an adversarial example patch is made, it is possible to neutralize the effectiveness of the attack and output bounding boxes that should be output as a result of object detection.

### Supplement to Embodiment 1

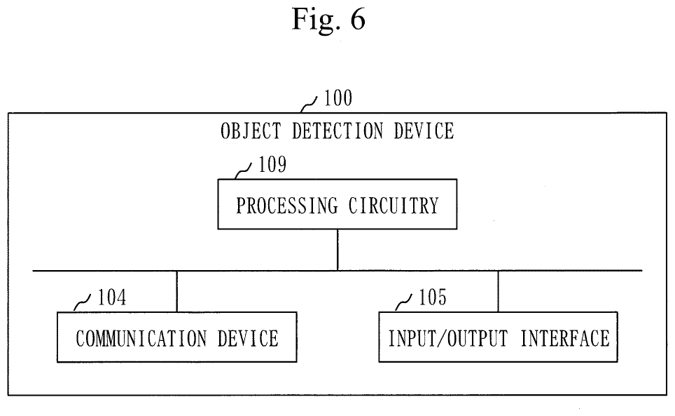

Based on FIG. 6, a hardware configuration of the object detection device 100 will be described.

The object detection device 100 includes processing circuitry 109.

The processing circuitry 109 is hardware that realizes the acceptance unit 110, the detection unit 120, the processing unit 130, the integration unit 140, and the output unit 150.

The processing circuitry 109 may be dedicated hardware, or may be the processor 101 that executes programs stored in the memory 102.

When the processing circuitry 109 is dedicated hardware, the processing circuitry 109 is, for example, a single circuit, a compound circuit, a programmed processor, parallel-programmed processors, an ASIC, an FPGA, or a combination of these.

ASIC is an abbreviation for application specific integrated circuit.

FPGA is an abbreviation for field programmable gate array.

The object detection device 100 may include a plurality of processing circuits as an alternative to the processing circuitry 109.

In the processing circuitry 109, some functions may be realized by dedicated hardware, and the remaining functions may be realized by software or firmware.

As described above, the functions of the object detection device 100 can be realized by hardware, software, firmware, or a combination of these.

Embodiment 1 is an example of a preferred embodiment and is not intended to limit the technical scope of the present disclosure. Embodiment 1 may be implemented partially, or may be implemented in combination with another embodiment. The procedures described using the flowcharts or the like may be suitably modified.

“Unit” of each element of the object detection device 100 may be interpreted as “process”, “step”, “circuit”, or “circuitry”.

### REFERENCE SIGNS LIST

100: object detection device; 101: processor; 102: memory; 103: auxiliary storage device; 104: communication device; 105: input/output interface; 109: processing circuitry; 110: acceptance unit; 120: detection unit; 121: first detection unit; 122: second detection unit; 130: processing unit; 140: integration unit; 141: first removal unit; 142: second removal unit; 150: output unit; 190: storage unit; 191: target image; 192: detection result; 193: filled image group; 194: detection result group; 195: first result set; 196: second result set; 197: object detection result.

1. An object detection device comprising
processing circuitry to:
perform object detection on a target image to calculate a detection result indicating a bounding box group;
obtain a filled image group by, for each target bounding box selected from the bounding box group of the target image, filling in the target bounding box in the target image to generate a filled image;
perform the object detection on the filled image for each filled image to obtain a detection result group for the filled image group;
perform a first removal process on a detection result set to obtain the detection result set after a redundant bounding box has been removed as a first result set, the detection result set being composed of the detection result for the target image and the detection result group for the filled image group; and
perform a second removal process on the first result set to obtain a second result set as a final result of the object detection on the target image, the second result set being the first result set after a redundant bounding box not removed by the first removal process has been removed.

2. The object detection device according to claim 1,
wherein each of the first removal process and the second removal process is a process of removing the redundant bounding box based on an area of an intersection of bounding boxes of each pair of bounding boxes.

3. The object detection device according to claim 1,
wherein each detection result further indicates a score value group for the bounding box group.

4. The object detection device according to claim 3,
wherein the first removal process selects a first reference bounding box in descending order of score values from the detection result set, and
each time the first reference bounding box is selected, uses each bounding box other than the first reference bounding box among bounding boxes in the detection result set as a first comparison bounding box, calculates a first evaluation value by dividing an area of an intersection of the first reference bounding box and the first comparison bounding box by an area of a union of the first reference bounding box and the first comparison bounding box, and removes the first comparison bounding box from the detection result set when the first evaluation value satisfies a first removal condition, and
wherein the second removal process selects a second reference bounding box in descending order of areas from the first result set, and
each time the second reference bounding box is selected, uses each bounding box other than the second reference bounding box among bounding boxes in the first result set as a second comparison bounding box, calculates a second evaluation value by dividing an area of an intersection of the second reference bounding box and the second comparison bounding box by an area of the second comparison bounding box, and removes the second comparison bounding box from the first result set when the second evaluation value satisfies a second removal condition.

5. The object detection device according to claim 3,
wherein the processing circuitry selects a bounding box corresponding to each score value that falls within a predetermined range as the target bounding box.

6. The object detection device according to claim 4,
wherein the processing circuitry selects a bounding box corresponding to each score value that falls within a predetermined range as the target bounding box.

7. The object detection device according to claim 2,
wherein each detection result further indicates a score value group for the bounding box group.

8. The object detection device according to claim 7,
wherein the first removal process selects a first reference bounding box in descending order of score values from the detection result set, and
each time the first reference bounding box is selected, uses each bounding box other than the first reference bounding box among bounding boxes in the detection result set as a first comparison bounding box, calculates a first evaluation value by dividing an area of an intersection of the first reference bounding box and the first comparison bounding box by an area of a union of the first reference bounding box and the first comparison bounding box, and removes the first comparison bounding box from the detection result set when the first evaluation value satisfies a first removal condition, and
wherein the second removal process selects a second reference bounding box in descending order of areas from the first result set, and
each time the second reference bounding box is selected, uses each bounding box other than the second reference bounding box among bounding boxes in the first result set as a second comparison bounding box, calculates a second evaluation value by dividing an area of an intersection of the second reference bounding box and the second comparison bounding box by an area of the second comparison bounding box, and removes the second comparison bounding box from the first result set when the second evaluation value satisfies a second removal condition.

9. The object detection device according to claim 7,
wherein the processing circuitry selects a bounding box corresponding to each score value that falls within a predetermined range as the target bounding box.

10. The object detection device according to claim 8,
wherein the processing circuitry selects a bounding box corresponding to each score value that falls within a predetermined range as the target bounding box.

11. An object detection method comprising:
performing object detection on a target image to calculate a detection result indicating a bounding box group;
obtaining a filled image group by, for each target bounding box selected from the bounding box group of the target image, filling in the target bounding box in the target image to generate a filled image;
performing the object detection on the filled image for each filled image to obtain a detection result group for the filled image group;
performing a first removal process on a detection result set to obtain the detection result set after a redundant bounding box has been removed as a first result set, the detection result set being composed of the detection result for the target image and the detection result group for the filled image group; and
performing a second removal process on the first result set to obtain a second result set as a final result of the object detection on the target image, the second result set being the first result set after a redundant bounding box not removed by the first removal process has been removed.

12. A non-transitory computer readable medium storing an object detection program to cause a computer to execute:
a first detection process of performing object detection on a target image to calculate a detection result indicating a bounding box group;
a processing process of obtaining a filled image group by, for each target bounding box selected from the bounding box group of the target image, filling in the target bounding box in the target image to generate a filled image;
a second detection process of performing the object detection on the filled image for each filled image to obtain a detection result group for the filled image group;
a first removal process of performing a first removal process on a detection result set to obtain the detection result set after a redundant bounding box has been removed as a first result set, the detection result set being composed of the detection result for the target image and the detection result group for the filled image group; and
a second removal process of performing a second removal process on the first result set to obtain a second result set as a final result of the object detection on the target image, the second result set being the first result set after a redundant bounding box not removed by the first removal process has been removed.
